(19) United States
(12) Patent Application Publication
(10) Pub. No.: US 2009/0267965 A1
(43) Pub. Date: Oct. 29, 2009

(54) Data Driving Circuits for Low Color Washout Liquid Crystal Devices

(76) Inventor: Kai-Shu Han, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/261,061

(22) Filed: Oct. 30, 2008

(30) Foreign Application Priority Data
Apr. 28, 2008 (TW) 097115554

(51) Int. Cl. G09G 5/10

(52) U.S. Cl. 345/690

(57) ABSTRACT

A data driving circuit for a low color wash-out liquid crystal display includes a serial-to-parallel conversion module for converting to output a plurality of sequentially received pixel data in parallel, a compensation data generation module for performing a function operation for the plurality of pixel data to generate a plurality of gamma compensation data, a digital-to-analog conversion module for performing digital-to-analog conversion for the plurality of pixel data and the plurality of gamma compensation data according to a gamma look-up table, and an operational amplifier module for generating a plurality of driving voltages of major pixels and a plurality of driving voltages of sub pixels according to analog signals outputted by the digital-to-analog conversion module to drive the major pixels and the sub pixels corresponding to a row of the liquid crystal display.

### BACKGROUND OF THE INVENTION

1. Field of the Invention

The present invention relates to a data driving circuit for a low color washout liquid crystal display, and more particularly, to a data driving circuit that utilizes a lowest system clock and least Gamma lookup tables to achieve Gamma compensation.

2. Description of the Prior Art

Since liquid crystal displays (LCDs) have the advantages of portability, low power consumption, and low radiation, the LCDs have been widely used in various portable information products, such as notebooks, personal digital assistants (PDAs), video cameras, etc. Furthermore, the LCD even has a potential to replace conventional cathode-ray tube (CRT) monitors or televisions gradually.

Compared with the CRT monitors, brightness and contrast of the LCD monitors are likely altered due to different viewing angles of the users, and even gray level inversion may occur when the viewing angle is too large. Thus, at present, some wide viewing angle LCD technologies, such as Multi-domain Vertical Alignment (MVA) and In-Plane Switching (IPS), are utilized to expand the viewing angle of the LCD. However, for the LCDs adopting the MVA technology, problems of color wash-out or Gamma curve shift still exist when the LCD screens are viewed with large viewing angles. That is to say, as the users move away from a position directly in front of the MVA LCD, contrast of the viewed image is increasingly poor, such that no difference is distinguishable between high brightness images. So, the image cannot be viewed clearly.

Since incident lights with different angles may have different transmittance when passing through liquid crystal layers, gray-scale coefficient curves, also known as Gamma curves, of the LCD screen viewed at different angles (e.g. a front view or a side view) are also different. Thus, monochromatic lights, such as trichromatic colors R, G, and B, are mixed with different ratios of gray levels at different viewing angles, resulting in differently viewed colors, which is the above-mentioned color wash-out effect.

In order to improve the color wash-out effect of the MVA LCD, the prior art usually utilizes Gamma compensation to mix at least two Gamma curves for generating a mixed Gamma curve that has same gray scale coefficients in different viewing angles. Generally, the Gamma compensation can be achieved in the following two ways: space compensation and time compensation. In the space compensation method, each pixel unit of the LCD is designed to comprise at least two sub-pixel units. Thus, at least two Gamma values corresponding to an original Gamma value can be display by the sub-pixel units at the same time, so as to obtain equivalent brightness and visual effect as the original Gamma curve based on a gray level averaging effect. In contrast, the time compensation takes advantage of visual persistence of human eyes to display at least two Gamma values corresponding to an original Gamma value during a frame time, so as to achieve a wide viewing angle effect. However, in both the space compensation and the time compensation, a data driving circuit needs an additional compensation pixel data to drive each pixel in the LCD. In this case, production cost of the driving circuit increases significantly.

First, please refer to FIG. 1. FIG. 1 is a schematic diagram of a conventional data driving circuit 10 for an LCD. The data driving circuit 10 has N effective outputs (i.e. for driving N pixels), and substantially includes a data register module 110, a digital-to-analog conversion module 120 and an operational amplifier module 130. The data register module 110 includes data registers RG_1˜RG_N, and is utilized for sequentially receiving pixel data DATA_1˜DATA_N according to a clock signal CLK, and outputting the pixel data DATA_1˜DATA_N in parallel according to a data load signal LD. The digital-to-analog conversion module 120 includes digital to analog converters DAC_1˜DAC_N, and is utilized for converting the pixel data DATA_1˜DATA_N to analog signals ANAG_1˜ANAG_N according to a Gamma look-up table Gamma_LUT (or a Gamma voltage generator). Then, the operational amplifier module 130 that includes operational amplifiers OP_1˜OP_N generates driving voltages to drive the N pixels in a row of the LCD according to the analog signals ANAG_1˜ANAG_N outputted by the digital-to-analog conversion module 120.

However, for the low color wash-out LCD that utilizes the Gamma compensation, the data driving circuit needs at least double a rate of the system clock or twice the number of the hardware circuitry to drive the same N pixels. For example, please refer to FIG. 2. FIG. 2 is a schematic diagram of a conventional data driving circuit 20 for a low color washout LCD that utilizes the space compensation. Similarly, the driving circuit 20 also includes a data register module 210, a digital-to-analog conversion module 220 and an operational amplifier module 230, and the related operations are not narrated again herein. Since each pixel of the LCD that utilizes the space compensation needs to be driven by at least two driving voltages at the same time, if the number of the Gamma look-up table is not increased, the circuitry elements of the data register module 210, the digital-to-analog conversion module 220 and the operational amplifier module 230 have to be doubled, and the system clock has to be doubled as well to receive N pixel data and N Gamma compensation data, so as to generate 2N driving voltages at the same time. In this case, chip production cost and electromagnetic interference (EMI) generated by the clock signal are also increased accordingly.

On the other hand, if the system clock is kept the same, the number of the Gamma look-up table has to be increased, so that the data driving circuit can generate driving voltages of major pixels and sub pixels at the same time according to received pixel data. Please refer to FIG. 3. FIG. 3 is a schematic diagram of a conventional data driving circuit 30 for a low color washout LCD that utilizes the space compensation. Since the system clock is kept the same, which means the number of pixel data capable of being received by the data driving circuit 30 at the same time also remains unchanged, gamma compensation data has to be generated inside the data driving circuit 30 to drive 2N sub pixels in a row of the LCD. As shown in FIG. 3, the data driving circuit 30 utilizes an additional Gamma look-up table to generate 2N driving voltages according to received pixel data. However, the additional Gamma table and its required wirings significantly increase the height of the chip layout, resulting in the increase of chip production cost.

In short, either enhancing the system clock or increasing the number of Gamma look-up table is adopted in the prior art to achieve the data driving circuit with function of Gamma compensation for improving color wash-out effect of the LCD monitors. However, enhancing the system clock may cause severe EMI problems, while increasing the number of the Gamma look-up table significantly increases the size of the driver chips, both of which lead to the increase of production cost.

### SUMMARY OF THE INVENTION

It is therefore an objective of the present invention to provide a data driving circuit for a low color washout liquid crystal display.

According to the present invention, a data driving circuit for a low color wash-out liquid crystal display is disclosed. The data driving circuit includes a serial-to-parallel conversion module, a compensation data generation module, a digital-to-analog conversion module and an operational amplifier module. The serial-to-parallel conversion module is utilized for sequentially receiving a plurality of pixel data and outputting the plurality of pixel data in parallel according to a load data signal. The compensation data generation module is coupled to the serial-to-parallel conversion module, and is utilized for generating a plurality of gamma compensation data respectively corresponding to the plurality of pixel data according to the plurality of pixel data. The digital-to-analog conversion module is coupled to the serial-to-parallel conversion module and the compensation data generation module, and is utilized for performing digital-to-analog conversion on the plurality of pixel data and the plurality of gamma compensation data according to a gamma look-up table. The operational amplifier module is coupled to the digital-to-analog conversion module, and is utilized for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

According to the present invention, a data driving circuit for a low color wash-out liquid crystal display is further disclosed. The data driving circuit includes a serial-to-parallel conversion module, a digital-to-analog conversion module and a driving voltage generation module. The serial-to-parallel conversion module is utilized for sequentially receiving a plurality of pixel data and outputting the plurality of pixel data in parallel according to a load data signal. The digital-to-analog conversion module is coupled to the serial-to-parallel conversion module, and is utilized for performing digital-to-analog conversion on the plurality of pixel data according to a gamma look-up table to generate a plurality of analog signals. The driving voltage generation module is coupled to the digital-to-analog conversion module, and includes a plurality of first operational amplifiers and a plurality of second operational amplifiers. The plurality of first operational amplifiers is coupled to the digital-to-analog conversion module, and is utilized for respectively generating a plurality of major pixel driving voltages according to the plurality of analog signals. The plurality of second operational amplifiers is coupled to the digital-to-analog conversion module, and is utilized for respectively generating a plurality of sub pixel driving voltages according to the plurality of analog signals. The plurality of major pixel driving voltages and the plurality of sub pixel driving voltages are utilized for driving a plurality of major pixels and a plurality of sub pixels in a row of the liquid crystal display.

According to the present invention, a data driving circuit for a low color wash-out liquid crystal display is further disclosed. The data driving circuit includes a shift register module, a compensation data generation module, a data latch module, a digital-to-analog conversion module and an operational amplifier module. The shift register module is utilized for converting a plurality of sequentially received pixel data to output in parallel. The compensation data generation module is coupled to the shift register module, and is utilized for generating a plurality of gamma compensation data respectively corresponding to the plurality of pixel data according to the plurality of pixel data. The data latch module is coupled to the shift register module and the compensation data generation module, and is utilized for latching the plurality of pixel data and the plurality of gamma compensation data and outputting the plurality of pixel data and the plurality of gamma compensation data according to a data load signal. The digital-to-analog conversion module is coupled to the data latch module, and is utilized for performing digital-to-analog conversion on the plurality of pixel data and the plurality of gamma compensation data according to a gamma look-up table. The operational amplifier module is coupled to the digital-to-analog conversion module, and is utilized for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

According to the present invention, a data driving circuit for a low color wash-out liquid crystal display is further disclosed. The data driving circuit includes a data input terminal, a compensation data generation module, a first serial-to-parallel conversion module, a second serial-to-parallel conversion module, a digital-to-analog conversion module and an operational amplifier module. The data input terminal is utilized for sequentially receiving a plurality of pixel data. The compensation data generation module is coupled to the data input terminal, and is utilized for sequentially generating a plurality of gamma compensation data corresponding to the plurality of pixel data. The first serial-to-parallel conversion module is coupled to the data input terminal, and is utilized for latching the plurality of pixel data and outputting the plurality of pixel data in parallel according to a data load signal. The second serial-to-parallel conversion module is coupled to the data input terminal, and is utilized for latching the plurality of gamma compensation data and outputting the plurality of gamma compensation data in parallel according to the data load signal. The digital-to-analog conversion module is coupled to the first serial-to-parallel conversion module and the second serial-to-parallel conversion module, and is utilized for performing digital-to-analog conversion for the plurality of pixel data and the plurality of gamma compensation data according to a gamma look-up table. The operational amplifier module is coupled to the digital-to-analog conversion module, and is utilized for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

According to the present invention, a data driving circuit for a low color wash-out liquid crystal display is further disclosed. The data driving circuit includes a shift register module, a compensation data generation module, a switch module, a digital-to-analog conversion module and an operational amplifier module. The shift register module is utilized for converting a plurality of sequentially received pixel data to output in parallel. The compensation data generation module is coupled to the shift register module, and is utilized for generating a plurality of gamma compensation data respectively corresponding to the plurality of pixel data according to the plurality of pixel data. The switch module is coupled to the shift register module and the compensation data generation module, and is utilized for switching to output the plurality of pixel data and the plurality of gamma compensation data. The digital-to-analog conversion module is coupled to the switch module, and is utilized for performing digital-to-analog conversion for the plurality of pixel data or the plurality of gamma compensation data switched by the switch module according to a gamma look-up table. The operational amplifier module is coupled to the digital-to-analog conversion module, and is utilized for generating a plurality of driving voltages according to analog signals outputted by the digital-to-analog conversion module to drive a plurality of pixels in a row of the liquid crystal display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional data driving circuit for a LCD.

FIG. 2 is a schematic diagram of a conventional data driving circuit for a low color washout LCD that utilizes the space compensation.

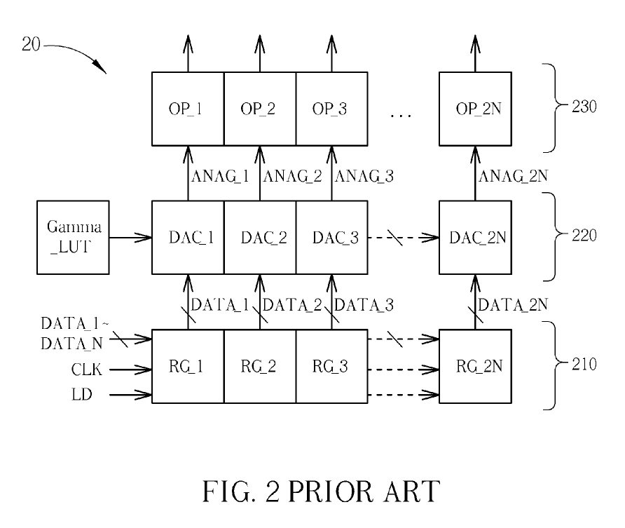

FIG. 3 is a schematic diagram of a conventional data driving circuit for a low color washout LCD that utilizes the space compensation.

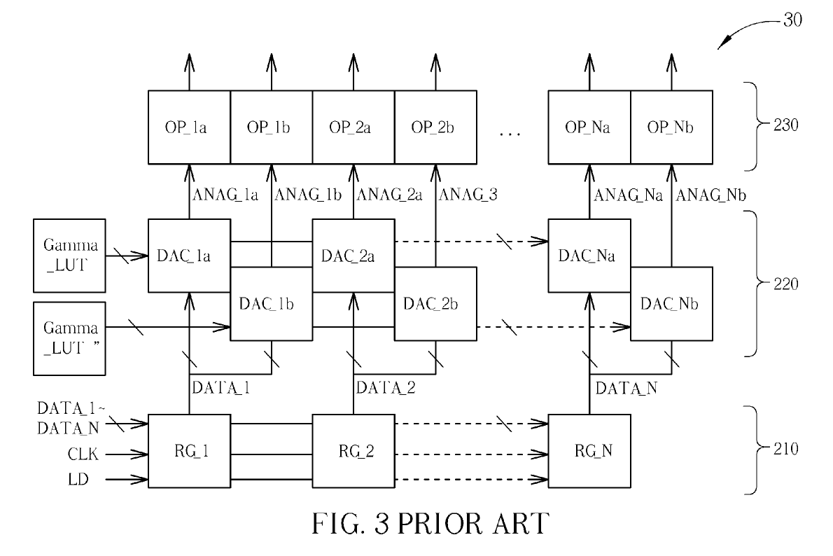

FIG. 4 is a schematic diagram of a data driving circuit for a low color wash-out LCD according to a first embodiment of the present invention.

FIG. 5 is a schematic diagram of a data driving circuit for a low color wash-out LCD according to a second embodiment of the present invention.

FIG. 6 is a schematic diagram of a data driving circuit for a low color wash-out LCD according to a third embodiment of the present invention.

FIG. 7 is a schematic diagram of a data driving circuit for a low color wash-out LCD according to a fourth embodiment of the present invention.

FIG. 8 is a schematic diagram of a data driving circuit for a low color wash-out LCD according to a fifth embodiment of the present invention.

FIG. 9 is a schematic diagram of a data driving circuit for a low color wash-out LCD according to an embodiment of the present invention.

### DETAILED DESCRIPTION

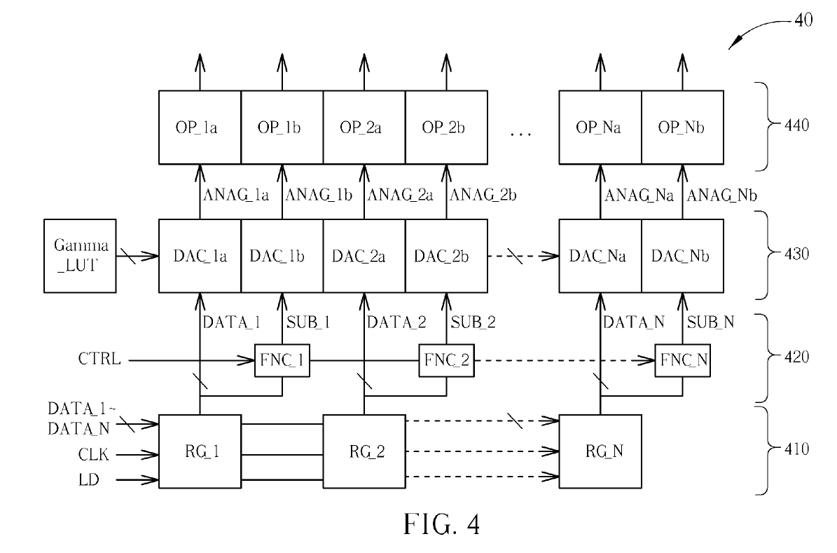

Please refer to FIG. 4. FIG. 4 is a schematic diagram of a data driving circuit 40 for a low color wash-out liquid crystal display (LCD) according to a first embodiment of the present invention. The data driving circuit 40 is a data driving circuit with N effective outputs (i.e. for driving N pixels), and includes a serial-to-parallel conversion module 410, a compensation data generation module 420, a digital-to-analog conversion module 430 and an operational amplifier module 440. The serial-to-parallel conversion module 410 is utilized for sequentially receiving pixel data DATA_1˜DATA_N according to a clock signal CLK, and outputting the pixel data DATA_1˜DATA_N in parallel according to a data load signal LD. The compensation data generation module 420 is coupled to the serial-to-parallel conversion module 410, and is utilized for computing the pixel data DATA_1˜DATA_N to generate corresponding gamma compensation data SUB_1˜SUB_N. The digital-to-analog conversion module 430 is coupled to the serial-to-parallel conversion module 410 and the compensation data generation module 420, and is utilized for performing digital-to-analog conversion for the pixel data DATA_1˜DATA_N and the gamma compensation data SUB_1˜SUB_N according to a gamma look-up table Gamma_LUT (i.e. a Gamma voltage generator). The operational amplifier module 440 is coupled to the digital-to-analog conversion module 430, and is utilized for generating driving voltages corresponding to the pixel data DATA_1˜DATA_N and the gamma compensation data SUB_1˜SUB_N to drive N major pixels and N sub pixels in a row of the LCD according to analog signals ANAG_1a˜ANAG_Na and ANAG_1b˜ANAG_Nb outputted by the digital-to-analog conversion module.

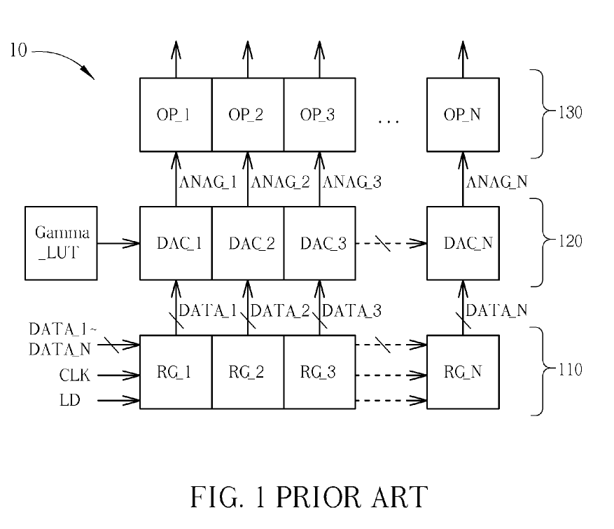

Related operations of the serial-to-parallel conversion module 410, the digital-to-analog conversion module 430 and the operational amplifier module 440 are similar to those of the data register module 110, the digital-to-analog conversion module 120 and the operational amplifier module 130 in FIG. 1, and are not narrated again herein. The compensation data generation module 420 includes functional operation circuits FNC_1˜FNC_N, which respectively perform a functional operation F(x) for the pixel data DATA_1˜DATA_N to generate corresponding gamma compensation data SUB_1˜SUB_N. That is to say, in the present invention, the gamma compensation data is converted from the major pixel data by the functional operation circuits FNC_1˜FNC_N, and the conversion function F(x) between the major pixel data and the Gamma compensation data is not limited as long as the color wash-out effect of the LCD can be improved by the Gamma compensation, which all belongs to the scope of the present invention. In addition, the conversion function of the functional operation circuits FNC_1˜FNC_N can also be a multi-variable function, like F(X, Y), wherein the variable Y can be configured by an external control signal CTRL, so that the flexibility of the data driving circuit can be enhanced in the present invention.

Preferably, the data driving circuit 40 is applied in a low color washout LCD that utilizes space compensation, and when each pixel of the LCD is composed of more than two sub-pixels, more than two functional operation circuits can also be realized in the data driving circuit 40 for performing the functional operation for each pixel data to generate corresponding amount of gamma compensation data. Such variation also belongs to the scope of the present invention. On the other hand, the functional operation circuits of the present invention can be realized by any analog or digital computation circuits, and in the serial-to-parallel conversion module 410, each data register unit RG_N is composed by a shift register and a data latch, which is well known by those skilled in the art, and thus not narrated herein.

Thus, by the compensation data generation module 420, the data driving circuit 40 of the present invention can perform the functional operation for the received pixel data to generate the driving voltages of the major pixels and the sub pixels simultaneously. In this case, the present invention can utilize a lowest system clock and least number of Gamma lookup tables to achieve Gamma compensation for improving the color washout effect of the LCD, so that production cost of the driver chip can be reduced significantly.

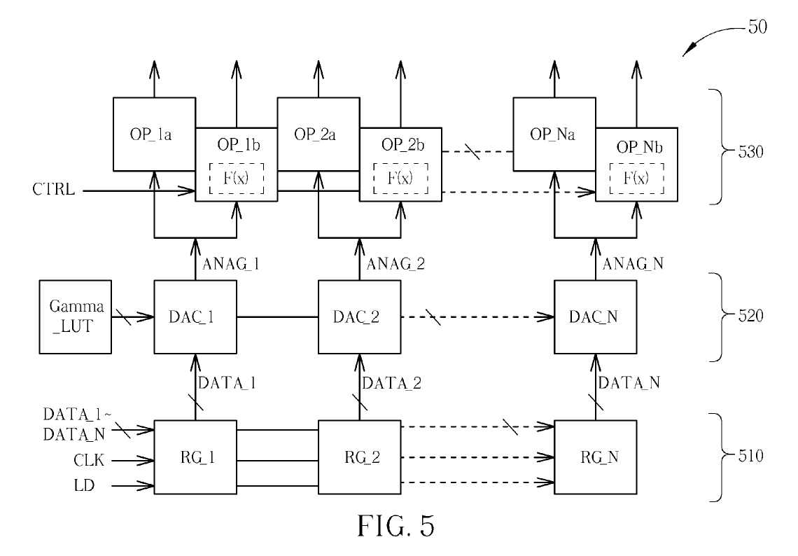

In addition, since the operational amplifier can be considered as a functional operation circuit, the present invention can further realize the conversion function F(x) utilized for generating the gamma compensation data into the operational amplifier module of the data driving circuit, so as to further reduce production cost of the driver chip. Please further refer to FIG. 5. FIG. 5 is a schematic diagram of a data driving circuit 50 for a low color wash-out LCD according to a second embodiment of the present invention. The data driving circuit 50 is a data driving circuit with N effective outputs, and includes a serial-to-parallel conversion module 510, a digital-to-analog conversion module 520 and an operational amplifier module 530. The serial-to-parallel conversion module 510 and the digital-to-analog conversion module 520 are similar to the serial-to-parallel conversion module 410 and the digital-to-analog conversion module 430 in FIG. 4, and not narrated again herein. The operational amplifier module 530 is coupled to the digital-to-analog conversion module 520, and includes first operational amplifiers OP_1a˜OP_Na and second operational amplifiers OP_1b˜OP_Nb. The first operational amplifiers OP_1a˜OP_Na are coupled to the digital-to-analog conversion module 520, and are utilized for performing voltage buffering for analog signals ANAG_1˜ANAG_N outputted by the digital-to-analog conversion module 520 to output driving voltages of major pixels. The second operational amplifiers OP_1b˜OP_Nb are coupled to the digital-to-analog conversion module 520, and are utilized for performing a functional operation F(X) for the analog signals ANAG_1˜ANAG_N to generate driving voltages of sub pixels.

That is to say, the data driving circuit 50 not only utilizes the first operational amplifiers OP_1a˜OP_Na to perform voltage buffering for the analog signals ANAG_1˜ANAG_N, but also utilizes the second operational amplifiers OP_1b˜OP_Nb to perform the functional operation for the analog signals ANAG_1˜ANAG_N to generate the driving voltages of the major pixels and the sub pixels at the same time. In this case, the present invention can utilize a lowest system clock and least number of Gamma lookup tables to achieve Gamma compensation for improving the color washout effect of the LCD, so that production cost of the driver chip can be reduced significantly.

Similarly, the data driving circuit 50 is applied in a low color wash-out LCD that utilizes the space compensation, and the second operational amplifiers OP_1b˜OP_Nb can further be configured by an external control signal CTRL to perform an operation of a multi-variable function, which is not narrated again herein.

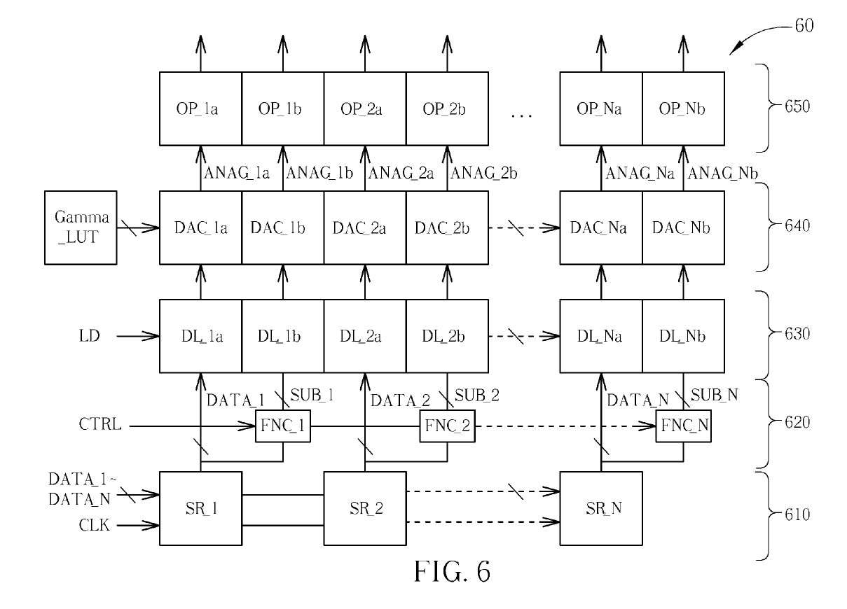

Certainly, the above conversion function F(X) utilized for generating gamma compensation data can also be realized into the serial-to-parallel conversion module of the data driving circuit. For example, please further refer to FIG. 6. FIG. 6 is a schematic diagram of a data driving circuit 60 for a low color wash-out LCD according to a third embodiment of the present invention. The data driving circuit 60 is a data driving circuit with N effective outputs, and includes a shift register module 610, a compensation data generation module 620, a data latch module 630, a digital-to-analog conversion module 640 and an operational amplifier module 650. The shift register module 610 includes shift registers SR_1˜SR_N, and is utilized for converting sequentially received pixel data DATA_1˜DATA_N to output in parallel according to a clock signal CLK. The compensation data generation module 620 is coupled to the shift register module 610, and includes functional operation circuits FNC_1˜FNC_N, which individually perform a functional operation F(x) for the pixel data DATA_1˜DATA_N to generate corresponding gamma compensation data SUB_1˜SUB_N. The data latch module 630 is coupled to the shift register module 620 and the compensation data generation module 610, and includes data latches DL_1˜DL_N, which are utilized for outputting the pixel data DATA_1˜DATA_N and the gamma compensation data SUB_1˜SUB_N being received according to a data load signal LD. Related operations of the digital-to-analog conversion module 640 and the operational amplifier module 650 are similar to that of the digital-to-analog conversion module 430 and the operational amplifier module 440 in FIG. 4, and are not narrated again.

Thus, in the data driving circuit 60, the conversion function F(X) utilized for generating the gamma compensation data is realized between the shift register module 610 and the data latch module 630, so that when the pixel data DATA_1˜DATA_N are outputted in parallel by the shift register module 610, the present invention can utilize the functional operation circuits FNC_1˜FNC_N to perform the functional operation for the pixel data DATA_1˜DATA_N to generate the corresponding gamma compensation data SUB_1˜SUB_N. In this case, the data driving circuit 60 can simultaneously generate the driving voltages of the major pixels and the sub pixels for improving the color washout effect of the LCD even if the rate of the system clock and the number of Gamma look-up tables are kept the same.

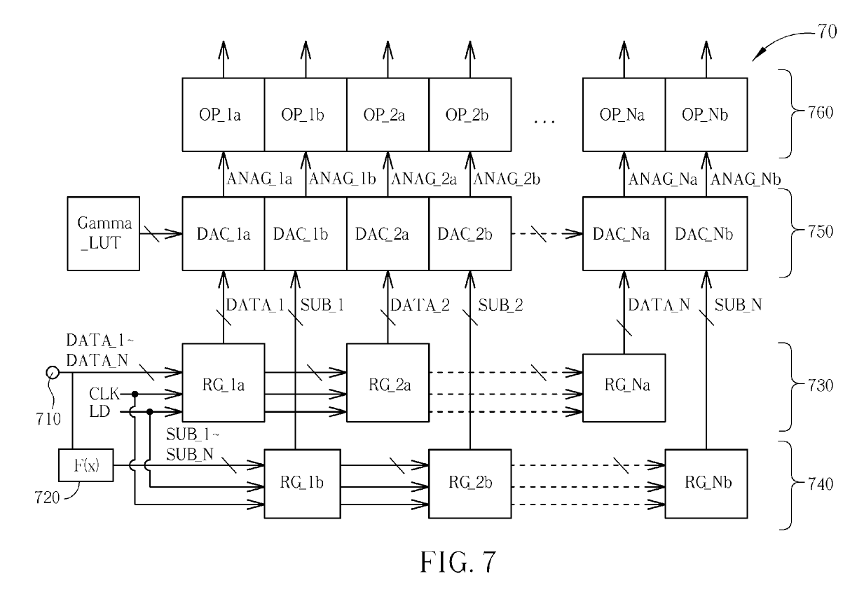

Please further refer to FIG. 7. FIG. 7 is a schematic diagram of a data driving circuit 70 for a low color wash-out LCD according to a fourth embodiment of the present invention. The data driving circuit 70 is a data driving circuit with N effective outputs, and includes a data input terminal 710, a functional operation circuit 720, a first serial-to-parallel conversion module 730, a second serial-to-parallel conversion module 740, a digital-to-analog conversion module 750 and an operational amplifier module 760. The data input terminal 710 is utilized for sequentially receiving pixel data DATA_1˜DATA_N. The functional operation circuit 720 is coupled to the data input terminal 710, and is utilized for performing a functional operation F(x) for the received pixel data DATA_1˜DATA_N to generate corresponding gamma compensation data SUB_1˜SUB_N in order. The first serial-to-parallel conversion module 730 is coupled to the data input terminal 710, and includes data registers RG_1a˜RG_Na. The first serial-to-parallel conversion module 730 is utilized for sequentially registering the pixel data DATA_1˜DATA_N according to a clock signal CLK, and outputting the pixel data DATA_1˜DATA_N in parallel according to a data load signal LD. The second serial-to-parallel conversion module 740 is coupled to the functional operation circuit 720, and includes data registers RG_1b˜RG_Nb. The second serial-to-parallel conversion module 740 is then utilized for sequentially registering the gamma compensation data SUB_1˜SUB_N according to the clock signal CLK, and outputting the gamma compensation data SUB_1˜SUB_N in parallel according to the data load signal LD. The digital-to-analog conversion module 750 and the operational amplifier module 760 are similar to the digital-to-analog conversion module 430 and the operational amplifier module 440 in FIG. 4, and are not narrate again.

Thus, in the present invention, the conversion function F(X) utilized for generating the gamma compensation data can also be realized prior to the data registers of the data driving circuit 70, so that the pixel data DATA_1˜DATA_N and the gamma compensation data SUB_1˜SUB_N generated by the functional operation circuit 720 can be latched simultaneously by the first and second serial-to-parallel conversion module 730 and 740. In this case, the data driving circuit 70 can simultaneously generate the driving voltages of the major pixels and the sub pixels for improving the color washout effect of the LCD under a situation that the rate of the system clock and the number of Gamma look-up tables are kept the same, so as to reduce production cost of the driver chips significantly. In addition, only one functional operation circuit needs to be set in the data driving circuit of this embodiment, and thus the circuit area required to perform the functional operation can be reduced as well.

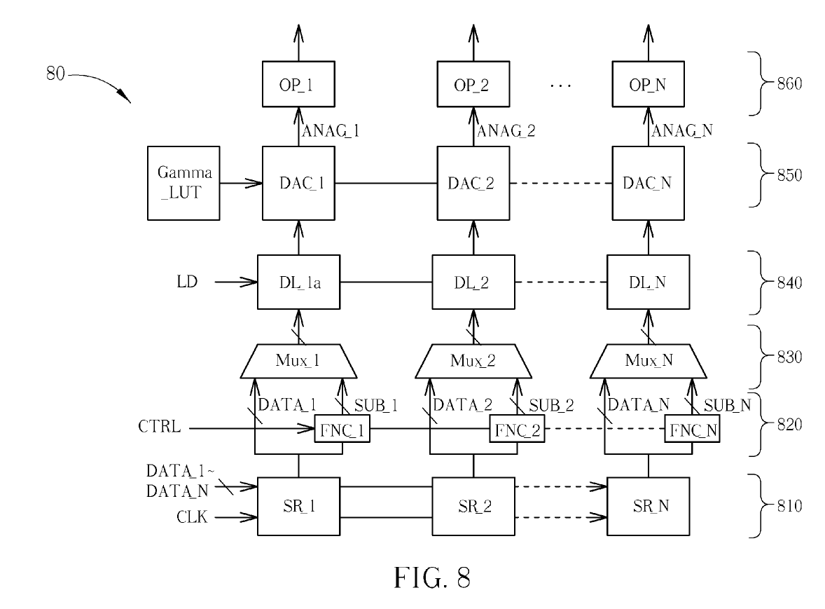

On the other hand, by appropriately arranging the functional operation circuit F(X) in the data driving circuit of the present invention, the low color wash-out LCD that adopts time compensation can also be driven by using the lowest system clock and the least number of Gamma lookup tables to generate driving voltages of major pixel data and compensation pixel data by turns in timing sequence. For example, please further refer to FIG. 8. FIG. 8 is a schematic diagram of a data driving circuit 80 for a low color wash-out LCD according to a fifth embodiment of the present invention. The data driving circuit 80 is a data driving circuit with N effective outputs, and includes a shift register module 810, a compensation data generation module 820, a switch module 830, a data latch module 840, a digital-to-analog conversion module 850 and an operational amplifier module 860. The shift register module 810 is utilized for converting sequentially received pixel data DATA_1˜DATA_N to output in parallel according to a clock signal CLK. The compensation data generation module 820 is coupled to the shift register module 810, and includes functional operation circuits FNC_1˜FNC_N, which are utilized for performing a functional operation F(x) individually for the pixel data DATA_1˜DATA_N to generate corresponding gamma compensation data SUB_1˜SUB_N. The switch module 830 is coupled to the shift register module 810 and the compensation data generation module 820, and includes multiplexers MUX_1˜MUX_n, which are utilized for switching to output the pixel data DATA_1˜DATA_N or the gamma compensation data SUB_1˜SUB_N. The data latch module 840 is coupled to the switch module 830, and is utilized for latching the pixel data DATA_1˜DATA_N or the gamma compensation data SUB_1˜SUB_N outputted by the switch module 830 and outputting the latched data according to a data load signal LD. The digital-to-analog conversion module 850 is coupled to the data latch module 840, and is utilized for performing digital to analog conversion for the pixel data DATA_1˜DATA_N or the gamma compensation data SUB_1˜SUB_N outputted by the data latch module 840 according to a gamma look-up table Gamma_LUT. The operational amplifier module 860 is coupled to the digital-to-analog conversion module 850, and is utilized for generating driving voltages corresponding to the pixel data DATA_1˜DATA_N or the gamma compensation data SUB_1˜SUB_N according to analog signals ANAG_1˜ANAG_N outputted by the digital-to-analog conversion module 850, so as to drive N pixels in a row of the LCD.

Thus, in the data driving circuit 80, the pixel data DATA_1˜DATA_N and the gamma compensation data SUB_1˜SUB_N generated by the functional operation F(x) are switched by the multiplexers, so that the driving voltages corresponding to the pixel data DATA_1˜DATA_N and the gamma compensation data SUB_1˜SUB_N can be generated by the digital-to-analog conversion module 850 and the operational amplifier module 860 by turns in timing sequence. In this case, the present invention can use the lowest system clock and the least number of Gamma lookup tables to achieve Gamma compensation in time domain for improving the color wash-out effect of the LCD. Therefore, compared with the prior art that has to use double rate of the system clock to achieve the time compensation, not only production cost of the data driving circuit can be reduced significantly, but also electrometric interference (EMI) caused by the clock signal can be improved in the present invention.

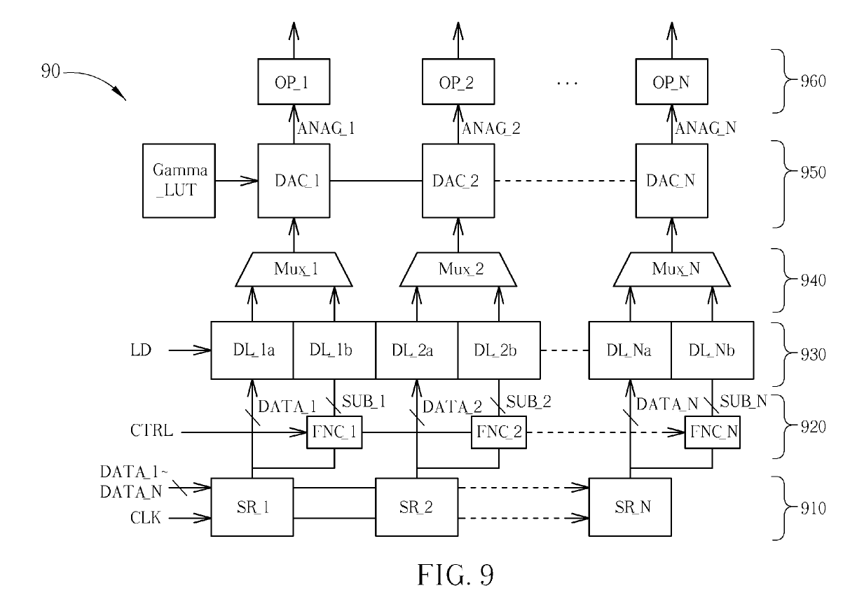

Please not that the data driving circuit for realizing the time compensation is not restricted in the embodiment of FIG. 8, those skilled in the art can certainly make proper modifications according to practical demands. For example, the functional operation circuits FNC_1˜FNC_N can also be arranged between the two stage data latches, i.e. between the shift registers and the data latches, as shown in FIG. 9, which also belongs to the scope of the present invention.

In addition, the compensation data generation modules in the above embodiments are not restricted by the functional operation circuits as well. The compensation pixel data or the compensation driving voltages can also be converted by other methods such as table look-up. Such variation also belongs to the scope of the present invention.

As mentioned above, the functional operation circuits utilized for generating the gamma compensation data are arranged into the data driving circuit of the present invention, so that the Gamma compensation can be realized by using the lowest system clock and the least number of Gamma lookup tables for improving the color washout effect of the LCD. In this case, not only production cost of the data driving circuit can be reduced significantly, but also EMI caused by the clock signal can be improved in the present invention.

Those skilled in the art will readily observe that numerous modifications and alterations of the device and method may be made while retaining the teachings of the invention.

What is claimed is:

1. A data driving circuit for a low color wash-out liquid crystal display comprising:
a serial-to-parallel conversion module for sequentially receiving a plurality of pixel data and outputting the plurality of pixel data in parallel according to a load data signal;
a compensation data generation module, coupled to the serial-to-parallel conversion module, for generating a plurality of gamma compensation data respectively corresponding to the plurality of pixel data according to the plurality of pixel data;
a digital-to-analog conversion module, coupled to the serial-to-parallel conversion module and the compensation data generation module, for performing digital-to-analog conversion on the plurality of pixel data and the plurality of gamma compensation data according to a gamma look-up table; and
an operational amplifier module, coupled to the digital-to-analog conversion module, for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

2. The data driving circuit of claim 1, wherein the compensation data generation module comprises a plurality of functional operation circuits for respectively performing a functional operation on the plurality of pixel data to generate the plurality of gamma compensation data.

3. The data driving circuit of claim 2, wherein the functional operation is a multi-variable functional operation.

4. The data driving circuit of claim 3, wherein the plurality of functional operation circuits performs the multi-variable functional operation according to a control signal.

5. The data driving circuit of claim 1, wherein a number of the plurality of gamma compensation data is equal to that of the plurality of pixel data.

6. A data driving circuit for a low color wash-out liquid crystal display comprising:
a serial-to-parallel conversion module for sequentially receiving a plurality of pixel data and outputting the plurality of pixel data in parallel according to a load data signal;
a digital-to-analog conversion module, coupled to the serial-to-parallel conversion module, for performing digital-to-analog conversion on the plurality of pixel data according to a gamma look-up table to generate a plurality of analog signals; and
a driving voltage generation module, coupled to the digital-to-analog conversion module, comprising:
a plurality of first operational amplifiers, coupled to the digital-to-analog conversion module, for respectively generating a plurality of major pixel driving voltages according to the plurality of analog signals; and
a plurality of second operational amplifiers, coupled to the digital-to-analog conversion module, for respectively generating a plurality of sub pixel driving voltages according to the plurality of analog signals;
wherein the plurality of major pixel driving voltages and the plurality of sub pixel driving voltages are utilized for driving a plurality of major pixels and a plurality of sub pixels in a row of the liquid crystal display.

7. The data driving circuit of claim 6, wherein the plurality of second operational amplifiers respectively performs a functional operation on the plurality of plurality of analog signals to generate the plurality of sub pixel driving voltages.

8. The data driving circuit of claim 7, wherein the functional operation is a multi-variable functional operation.

9. The data driving circuit of claim 8, wherein the plurality of second operational amplifiers perform the functional operation according to a control signal.

10. The data driving circuit of claim 6, wherein a number of the plurality of first operational amplifiers is equal to that of the plurality of second operational amplifiers.

11. A data driving circuit for a low color wash-out liquid crystal display comprising:
a shift register module for converting a plurality of sequentially received pixel data to output in parallel;
a compensation data generation module, coupled to the shift register module, for generating a plurality of gamma compensation data respectively corresponding to the plurality of pixel data according to the plurality of pixel data;
a data latch module, coupled to the shift register module and the compensation data generation module, for latching the plurality of pixel data and the plurality of gamma compensation data and outputting the plurality of pixel data and the plurality of gamma compensation data according to a data load signal;
a digital-to-analog conversion module, coupled to the data latch module, for performing digital-to-analog conversion on the plurality of pixel data and the plurality of gamma compensation data according to a gamma look-up table; and
an operational amplifier module, coupled to the digital-to-analog conversion module, for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

12. The data driving circuit of claim 11, wherein the compensation data generation module comprises a plurality of functional operation circuits for respectively performing a functional operation for the plurality of pixel data to generate the plurality of gamma compensation data.

13. The data driving circuit of claim 12, wherein the functional operation is a multi-variable functional operation.

14. The data driving circuit of claim 13, wherein the plurality of functional operation circuits perform the functional operation according to a control signal.

15. The data driving circuit of claim 11, wherein a number of the plurality of gamma compensation data is equal to that of the plurality of pixel data.

16. A data driving circuit for a low color wash-out liquid crystal display comprising:
a data input terminal for sequentially receiving a plurality of pixel data;
a compensation data generation module, coupled to the data input terminal, for sequentially generating a plurality of gamma compensation data corresponding to the plurality of pixel data;
a first serial-to-parallel conversion module, coupled to the data input terminal, for latching the plurality of pixel data and outputting the plurality of pixel data in parallel according to a data load signal;
a second serial-to-parallel conversion module, coupled to the data input terminal, for latching the plurality of gamma compensation data and outputting the plurality of gamma compensation data in parallel according to the data load signal;
a digital-to-analog conversion module, coupled to the first serial-to-parallel conversion module and the second serial-to-parallel conversion module, for performing digital-to-analog conversion for the plurality of pixel data and the plurality of gamma compensation data according to a gamma look-up table; and
an operational amplifier module, coupled to the digital-to-analog conversion module, for generating a plurality of major pixel driving voltages corresponding to the plurality of pixel data and a plurality of sub pixel driving voltages corresponding to the plurality of gamma compensation data according to analog signals outputted by the digital-to-analog conversion module to drive a plurality of major pixels and a plurality of sub pixels in a row of the liquid crystal display.

17. The data driving circuit of claim 16, wherein the compensation data generation module comprises a functional operation circuit for sequentially performing a functional operation on the plurality of pixel data to generate the plurality of gamma compensation data.

18. The data driving circuit of claim 17, wherein the functional operation is a multi-variable functional operation.

19. The data driving circuit of claim 18, wherein the functional operation circuit performs the multi-variable functional operation according to a control signal.

20. The data driving circuit of claim 16, wherein a number of the plurality of gamma compensation data is equal to that of the plurality of pixel data.

21. A data driving circuit for a low color wash-out liquid crystal display comprising:
a shift register module for converting a plurality of sequentially received pixel data to output in parallel;
a compensation data generation module, coupled to the shift register module, for generating a plurality of gamma compensation data respectively corresponding to the plurality of pixel data according to the plurality of pixel data;
a switch module, coupled to the shift register module and the compensation data generation module, for switching to output the plurality of pixel data and the plurality of gamma compensation data;
a digital-to-analog conversion module, coupled to the switch module, for performing digital-to-analog conversion for the plurality of pixel data or the plurality of gamma compensation data switched by the switch module according to a gamma look-up table; and
an operational amplifier module, coupled to the digital-to-analog conversion module, for generating a plurality of driving voltages according to analog signals outputted by the digital-to-analog conversion module to drive a plurality of pixels in a row of the liquid crystal display.

22. The data driving circuit of claim 21, wherein the compensation data generation module comprises a plurality of functional operation circuits for respectively performing a functional operation on the plurality of pixel data to generate the plurality of gamma compensation data.

23. The data driving circuit of claim 22, wherein the functional operation is a multi-variable functional operation.

24. The data driving circuit of claim 23, wherein the plurality of functional operation circuits perform the multi-variable functional operation according to a control signal.

25. The data driving circuit of claim 21 further comprising a data latch module, coupled between the switch module and the digital-to-analog conversion module, for latching the plurality of pixel data or the plurality of gamma compensation data switched by the switch module, and outputting the plurality of pixel data or the plurality of gamma compensation data according to a data load signal.

26. The data driving circuit of claim 21 further comprising:
a first data latch module, coupled between the shift register module and the switch module, for latching the plurality of pixel data and outputting the plurality of pixel data according to a data load signal; and
a second data latch module, coupled between the compensation data generation module and the switch module, for latching the plurality of gamma compensation data and outputting the plurality of gamma compensation data according to the data load signal.
